(19) United States
(12) Patent Application Publication
(10) Pub. No.: US 2011/0115165 A1
(43) Pub. Date: May 19, 2011

(54) FORM-IN-PLACE GASKET FOR SHAKER SCREEN

(76) Inventors: Barry R. Spigener, Arlington, TX (US); James D. Gillhespy, Whitehall, MI (US); Scott Carmichael, East Grand Rapids, MI (US)

(21) Appl. No.: 12/619,709

(22) Filed: Nov. 17, 2009

(51) Int. Cl. F16J 15/02

(52) U.S. Cl. 277/316

(57) ABSTRACT

A form-in-place technique for applying a gasket directly to a surface of a screen frame used in a vibratory separator is provided. The process includes a step of depositing a material onto a surface of the screen frame to form a continuous strip of the material along the surface of the screen frame, and curing the material to form the gasket.

### FIELD OF THE INVENTION

This invention pertains to the field of vibratory separators and shale shakers, and more particularly to seals or gaskets for screen assemblies used on vibrating separators.

### BACKGROUND OF THE INVENTION

Vibrating screens have been employed for many years to separate particles in a wide variety of industrial applications. Common applications for vibrating screens include drilling operations to separate particles suspended in drilling fluids. The screens are mounted generally horizontally on a vibrating mechanism or shaker that imparts a desired motion to the screen. Material from which particles are to be separated is poured onto a back end of the vibrating screens, usually from a pan mounted above the screens. The material generally flows toward the end of the screens. Large particles are unable to move through the screens remaining on top of the screens and moving toward the front of the screens where they are collected. The smaller particles and fluid flow through the screens and collects in a tank, receptacle or pan beneath the screens.

Typically the vibrating screens are resiliently suspended or mounted upon a support and are caused to vibrate by a vibrating mechanism, e.g., an unbalanced weight on a rotating shaft connected to a basket or frame. The screens are vibrated by vibratory equipment to create a flow of trapped solids on top surfaces of the screens, typically for removal and disposal of the solids. The fineness or coarseness of the mesh of a screen may vary depending upon mud flow rate and the size of the solids to be removed.

The gaskets or seal members used on vibratory separators, such as shale shakers, are typically located at the interface of a screen frame and vibratory separator housing members, and/or between adjacent screen frames. The gaskets are typically made of a resilient material that performs a sealing function to prevent materials being processed from bypassing the mesh screens, such as by flowing around the outside of the screened frame.

Heretofore, gaskets or seal members have generally been prefabricated separately from the screen frames, and have been subsequently secured to the screen frames with an adhesive material, a friction or interference fit, mechanical fasteners, or a combination of these means.

It has also been proposed that a gasket or seal member may be integrally molded with a composite screen frame by positioning the screen frame within a mould tool, and using an injection moulding technique to form the gasket on a surface of the screen frame within the mould tool.

### SUMMARY OF THE INVENTION

The invention is directed to a form-in-place technique in which a gasket is formed directly on a surface of a screen frame to be used in a vibratory separator by depositing a material onto a surface of the screen frame to form a continuous strip of the material along the surface of the screen frame, and curing the material to form the gasket. An advantage of certain embodiments of the invention is that the material deposited on the screen frame bonds directly with the surface of the screen frame, eliminating the need for using a separate adhesive or mechanical fasteners to secure the gasket to the screen frame.

### DETAILED DESCRIPTION OF PREFERRED EMBODIMENT

The invention provides an improved method for establishing a suitable seal between screen frames and/or a screen frame and vibratory housing members. The process involves forming a gasket on surfaces of the screen frame by depositing a suitable material directly onto the surface of the frame, generally along perimeter surfaces of the frame. Among other things, the method of the invention provides improved adhesion between a screen frame and a gasket, and eliminates the need for adhesives and/or fasteners for attaching the gasket to the screen frame. Other advantages of the invention include extended service life, the ability to repair onsite, and a reduced need for inventory of different types of gaskets.

As used herein, the term “depositing” and variations thereof refer to any suitable technique for disposing a flowable material on the surface of a screen frame so that it can be cured (e.g., cross-linked or otherwise hardened or solidified) in place on the screen frame. Examples of suitable techniques for depositing a curable material on a screen frame include spraying, brushing, and troweling. A preferred technique for depositing a curable material in accordance with certain aspects of the invention involves extruding the curable material onto a surface of a screen frame.

As used herein, the term “extruding” and variations thereof refer to a process used to form gaskets or seal members having a substantially fixed or constant cross-sectional profile by forcing an extrudable material through a die having a desired cross-sectional shape and size, wherein the extrudable material does not flow appreciably merely under the influence of gravity, but will flow when forced through the die opening. Suitable extrudable materials typically have a viscosity of from about 10,000 pascal-seconds to about 30,000 pascal-seconds. However, somewhat higher or lower viscosity materials may be employed provided that the viscosity is not so low as to allow excessive flow under only the influence of gravity that prevents formation of a useable gasket, and is not so high as to make extrusion through a die impractical.

As used herein, the term “curing” and variations thereof refer to a process used to harden and/or solidify a deposited material. With respect to thermosettable extrudable materials used in methods in accordance with the invention, the term “curing” encompasses various techniques for cross-linking polymer(s), pre-polymer(s), and/or oligomer(s) to form a cross-linked network or thermoset material. Such techniques may involve the use of chemical additives (e.g., cross-linking agents, cross-linking catalysts, cross-linking initiators, etc.), heat, moisture or humidity (e.g., cross-linking by a combination of hydrolysis and/or condensation reactions), and/or radiation (e.g., ultraviolet radiation, electron beam radiation, etc.). In certain aspects of the invention, the term “curing” may also be used to encompass other types of processes in which a deposited material is hardened and/or solidified, such as by fusion of a thermoplastic material that is deposited in a molten or semi-molten state.

Suitable thermosettable compositions include those that are formulated to cure rapidly upon exposure to heat and/or moisture. In such cases, curing can be affected or accelerated by subjecting the extruded materials to elevated moisture levels and/or elevated temperatures immediately after (and possibly during) extrusion.

Generally, the gasket that is formed in-place in accordance with this invention has appropriate elastomeric properties and sufficient toughness to withstand the vibration, movement and extremely variable pressures to which it will be subjected when used in a vibratory separation process and apparatus.

The diameter of a gasket material having a circular cross-sectional shape or the largest cross-sectional dimension of a gasket material having a non-circular cross-sectional shape is typically from about 0.5 inch to about 0.75 inch. However, in certain cases larger or smaller dimensions may be desirable.

Desirably, the material that is deposited in accordance with certain aspects of this invention is a thermosettable polymeric material that can be thermoset to form a gasket material that will adhere tenaciously to a metal surface (e.g., steel, aluminum, brass, etc.), a painted metal surface, an electrophoretically coated metal surface, a galvanized metal (e.g., steel or iron) and/or a powder coated metal surface of a screen frame for use in a vibratory separator. It is also desirable that the deposited material is sufficiently gelled and substantially tack free immediately after or shortly after being extruded so as to allow packaging and stacking of the screen frames on which the material has been extruded without adversely affecting the functionality of the gasket ultimately formed upon substantially complete curing of the extruded material.

Thermosettable compositions that may be used in practicing the invention include one-part and two-part systems. As is well known in the art, a two-part system refers to one in which certain components of a thermosettable composition are isolated from other components until immediately before the composition is used. In such systems, the prepolymer, polymer, and/or oligomers are typically in one part, and a second part includes cross-linking initiators. A preferred one-part system comprises a moisture curable composition containing a silyl-terminated polyether.

It is also desirable that the deposited material is capable of achieving a Shore A Durometer value of 20 to 100 (more desirably 55 to 75) when substantially fully cured, in order to allow suitable expansion of the gasket under clamping pressure. Substantially fully cured means that the composition is substantially inert and/or that the polymers, pre-polymers and/or oligomers will not undergo any significant further polymerization or cross-linking, and/or that the physical properties of the material will not further change appreciably over time. In certain embodiments, it is preferred that the gasket material, upon becoming substantially fully cured, will undergo cohesive failure rather than adhesive failure when tested to failure (e.g., peel testing), and will have a service life that exceeds the service life of the mesh screen mounted on the screen frame.

In certain embodiments, it is desirable that the fully cured gasket have a minimum service temperature of 230° F., and that the deposited material can be applied at generally any temperature from ambient or room temperature (about 70° F.) to about 250° F.

Depending upon the specific application, it is often desirable that the cured gasket exhibit exceptional chemical resistance and heat resistance. Typically, the gasket material is selected to provide sufficient chemical resistance to avoid degradation upon persistent contact with diesel fuel during its service life.

There are a variety of extrudable materials that can be cured to provide gaskets in accordance with the methods of this invention and which meet some, most, or all of the desirable performance attributes mentioned herein.

Suitable extrudable, curable compositions that may be employed in accordance with certain aspects of this invention include polyurethane systems, stryrenic block co-polymer systems, silyl-terminated polyether mastic compositions, polyurethane mastic compositions, silyl-terminated polyurethane compositions and compositions containing hybrid end-capped silonol-terminated polymers.

The following examples and formulas are illustrative of suitable depositable or extrudable materials which may be used in the methods of this invention. However, the invention is not limited to the specific examples and formulas set forth herein, but also encompass other materials that are capable of achieving a suitable result in accordance with the claimed invention.

### Example 1

A polyurethane mastic is produced by reacting a polytetramethylene ether glycol with crude methylene diphenyl diisocyanate, in the appropriate isocyante:hydroxyl ratio to produce a pre-polymer having an NCO content of less than 4%. At the appropriate time during the reaction an antioxidant such as Irganox 1135 should be added to the final blend. The final blend is used for extruding a gasket onto a surface of a screen frame used in a vibratory separator.

### Example 2

A solvent cast elastomer is made from a solid portion dissolved in a solvent. The solid portion comprises 100 parts Kraton G1652, 20-30 parts poly-alpha-methyl styrene resin, such as Endex 155 or 160, 10-40 parts of a hydrocarbon resin such as Escorez 5300, and 0.1-3 parts of an anti-oxidant such as Irganox 1010. The solid portion should be dissolved into a solvent at a 10-45% w/w ratio of solid to the solvent. The solvent portion is made up of 35% by weight of toluene, 35% by weight of xylene, and 30% by weight of tert-butyl acetate. The solvent cast elastomer is used for extruding a gasket onto a surface of a screen frame used in a vibratory separator.

### Example 3

A silyl-polyether mastic is made from 25-30 parts trimethoxysilylpropylcarbamate terminated polyether and 5-10 parts of a low modulus silyl polyether such as S203H, 10-20 parts diisodecyl phthalate plasticizer, 1-2 parts water scavenger, such as Geniosil XL 10, 2-5 parts fumed silica, 40-50 parts calcium carbonate; 1-5 parts titanium dioxide, 0.1-2 parts hindered amine light stabilizer; 1-2 parts organofuctional silane; 0.05-0.5 aminosilane, 0.05-0.5 parts dibutyltindilaurate. The mastic is used for extruding a gasket onto a surface of a screen frame used in a vibratory separator.

### Example 4

A mastic is made from 20-30 parts of a silyl-terminated polyurethane pre-polymer, such as Desmoseal S XP 2636; 10-20 parts plasticizer such as Unimol BB; 40-60 parts filler such as calcium carbonate; 1-3 parts fumed silica such as Cabosil PTG, and 0.1-0.5 parts condensation catalyst such as DABCO T-12. The mastic is used for extruding a gasket onto a surface of a screen frame used in a vibratory separator.

An advantage of the invention is that a single extrusion apparatus or other deposition technique can be easily used for quickly forming gaskets directly on a variety of different screen frames, having different sizes and different shapes, and/or a variety of screen frames requiring gaskets having different profiles (cross-sectional shapes) or different cross-sectional dimensions. Such modifications can be quickly made to an extrusion apparatus by changing the die or extrusion head of the apparatus. Such flexibility eliminates the need for maintaining an inventory comprised of a large variety of different pre-formed gaskets.

The invention also enables emergency repairs onsite, as needed, employing handheld applicators.

While the invention is expected to be particularly useful for shale shaker operations at gas and/or oil wells, other possible applications include use of the invention for vibratory separators employed in the petrochemical, mining, food processing, polymer, pharmaceutical, ceramic, paper and pulp, and abrasives industries. More generally, the methods of the invention have potential application and advantages in any industry using screens or sieves in a vibratory apparatus for separating or sorting particles from muds, suspensions, slurries, or a mixture of different size particles.

The invention claimed is:

1. A method of forming a gasket on a surface of a screen frame for use in a vibratory separator, comprising:
depositing a material onto a surface of the screen frame to form a continuous strip of the material along the surface of the screen frame; and
curing the material to form the gasket.

2. The method of claim 1, wherein the gasket has a largest cross-sectional dimension of from about 0.5 inch to about 0.75 inch.

3. The method of claim 1, wherein the material is extruded and is comprised of a thermosettable polymeric material.

4. The method of claim 1, wherein the surface of the screen frame is a metal, a painted metal, an electrophoretically cooked metal, a galvanized metal or a powder coated metal.

5. The method of claim 1, wherein the cured gasket exhibits a Shore A durometer value of 20 to 100.

6. The method of claim 1, wherein the material is extruded and is a polyurethane mastic.

7. The method of claim 1, wherein the material is extruded and is a solvent cast elastomer made from a poly-alpha-methyl styrene resin.

8. The method of claim 1, wherein the material is extruded and is a silyl polyether mastic.

9. The method of claim 1, wherein the material is extruded and is a mastic made from a silyl-terminated polyurethane prepolymer.

10. The method of claim 1, wherein the cured gasket will undergo cohesive failure rather than adhesive failure when tested to failure.

11. The method of claim 1, wherein the material is extruded and is a one-part moisture curable composition.

12. The method of claim 1, wherein curing is affected or accelerated by subjecting the material to an elevated temperature and/or an elevated humidity.

13. The method of claim 1, wherein the material is extruded and is a two-part thermosettable composition.
